(19) United States
(12) Patent Application Publication
(10) Pub. No.: US 2026/0225107 A1
(43) Pub. Date: Aug. 6, 2026

(54) Cardboard Shredder Device and Method

(71) Applicants: Lukasz Urbanski, Poway, CA (US); Malgorzata Urbanska, Poway, CA (US)

(72) Inventors: Lukasz Urbanski, Poway, CA (US); Malgorzata Urbanska, Poway, CA (US)

(21) Appl. No.: 19/287,782

(22) Filed: Jul. 31, 2025

Related U.S. Application Data
(60) Provisional application No. 63/753,917, filed on Feb. 4, 2025.

(51) Int. Cl. B02C 18/14; B02C 18/00; B02C 18/24

(52) U.S. Cl. CPC B02C 18/142; B02C 18/0092; B02C 18/146; B02C 18/24

(57) ABSTRACT

A handheld shredding device is provided having a housing with at least one handle extending therefrom for gripping by a user during use. A first opening aligned with a shredder assembly within the housing provides a path for the user to feed material to be shredded into the shredding device where it exits from a second opening. The shredding device is powered by a powered tool, such as a drill or may have an onboard motor powered by a rechargeable battery.

### BACKGROUND OF THE INVENTION

### 1. Field of the Invention

This application claims priority to U.S. Provisional patent application Ser. No. 63/753,917 filed on Feb. 4, 2025.

The invention herein disclosed relates generally to paper and cardboard shredding. More particularly, it relates to a hand-held shredder operating to shred packaging material, such as boxes.

### 2. Prior Art

### Background of the Invention

Cardboard has become an increasingly vital material across various industries, with its use expanding far beyond traditional packaging. Once primarily associated with shipping boxes, cardboard is now utilized in construction, furniture, and even art.

In the world of consumer products, cardboard has found its way into everything, from fashion accessories to children's toys, offering a more sustainable alternative to plastic. In art and design, cardboard is prized for its flexibility and texture, enabling creators to craft intricate sculptures and installations. As industries seek to embrace greener practices, cardboard's expanding role underscores its adaptability and growing importance in the modern world.

As sustainability concerns grow, cardboard's eco-friendly properties, such as its recyclability and biodegradability, make it an attractive alternative to plastic and other non-renewable

materials. Companies in the retail and e-commerce sectors, for instance, are exploring new ways to create durable and lightweight packaging solutions, while also reducing their environmental footprint. This shift toward cardboard reflects a broader trend of adopting renewable and biodegradable materials in the pursuit of more sustainable production and consumption.

For consumers, this ever widening use of cardboard can become an issue when trying to dispose of it in an ecological fashion. Most municipalities now require special containers for placement of plastic and cardboard to enable easy recycling. However, the sturdiness of boxes and the like formed of such material makes it hard to easily fill recycling containers in an easy fashion.

With respect to the above, before explaining at least one preferred embodiment of the handheld shredding device and method herein, it is to be understood that the disclosed shredder device herein is not limited in its application to the details of employment and to any arrangement of steps set forth in the following description or illustrated in the drawings. The various shredding apparatus components and configurations thereof, and methods of employment thereof as herein disclosed, are capable of other embodiments, and of being practiced and carried out in various ways, to those skilled in the art subsequent to their review of this specification.

Also, it is to be understood that the phraseology and terminology employed herein are for the purpose of description for an understanding of the shredding device and system herein and should not be regarded as limiting. As such, those skilled in the art will appreciate that the conception upon which this disclosure is based may readily be utilized as a basis for other shredding devices employable to shred paper and cardboard and the like. It is important, therefore, that the embodiments, objects and claims herein, be regarded as including such equivalent construction and methodology insofar as they do not depart from the spirit and scope of the present invention.

### SUMMARY OF THE INVENTION

The apparatus and system herein provides for an improved apparatus and method for the easy tearing of cardboard and other fiber-based packaging into small and more easily recycled material. The device features a shredding assembly positioned within a housing. One, or a plurality of, handles are engaged with the housing depending on the configuration of the power source which operates the counter rotating blades of the shredding assembly.

In one mode of the shredding device herein, it is configured for operative engagement with a handled power tool,

such as a power drill or powered ratchet. In this configuration, the shredding assembly is positioned within a housing having a first opening on a face of the housing. A handle may be engaged with the housing and extend in a direction away from the first opening.

A shaft extending from one side of the housing is connected to the counter rotating blades within the blade assembly. Rotation of this shaft will counter rotate the two shredding blades within the blade assembly. This shaft is configured for operative engagement with a hand-held power tool such as a power drill or a powered ratchet or the like, such that actuation of the power tool will cause it to rotate the shaft to which it is engaged. In this mode of the shredding device, the handle of the power tool provides a second handle to hold and actuate the device during use. As can be discerned, with one hand of the user gripping the first handle and the second hand of the user gripping the handle of the power tool, the housing and shedding assembly are held steady during shedding of material.

In the shredding process, material to be shredded such as cardboard and other thick paper products employed for packaging, is fed into the first opening. This first opening communicates with an area in-between the two counter rotating blades of the shredding assembly. As the blades rotate during use, they operate to also pull the material being shredded into the shredding assembly wherein it is shredded into small pieces which exit through an exit opening positioned on a bottom or lower surface of the housing surrounding the shredding assembly. In this fashion during use, paper, cardboard, or plastic and the like fed into the first opening in solid pieces will be shredded by the shredding assembly into smaller pieces which can then be more easily and compactly positioned into containers for recycling.

The shredding device may also be configured with an onboard power source in the form of an electric motor operatively connected to a battery or other electric power source. In this configuration of the device, a second handle may be engaged with the housing and extends from a coupling with the housing in a direction away from the first opening. A trigger to actuate the electric motor to rotate the counter rotating blades of the shredding assembly is positioned for easy use on one of the first handle or the second handle. This allows the user holding the shredding device with both hands, to push or position the device to cause material to be shredded to enter the first opening.

The counter rotating blades will then pull the material through the shredding assembly and push shredded sections of the material from the second opening in the bottom or lower side of the housing. One of the two handles may be positioned at a descending angle relative to the other handle, which extends substantially level with the housing. This configuration allows the user to hold the device with two hands with one hand lower than the other, which has shown to allow for easier control of the shredding device to resist rotation of the housing during use.

With respect to the above summary description, before explaining at least one preferred embodiment of the portable handheld shredding device system herein, it is to be understood that the invention is not limited in its application to the details of operation nor the arrangement of the components or the steps set forth in the following description or illustrations in the drawings. The various methods of implementation and operation of the portable handheld shredding device and method herein, are capable of other embodiments and of being practiced and carried out in various ways which will be obvious to those skilled in the art upon their review of this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis by others for the designing of other modes for carrying out the several purposes of the present handheld shredding device and system. Therefore, the objects and claims herein should be regarded as including such equivalent construction, steps, and methodology insofar as they do not depart from the spirit and scope of the present invention.

As used in the claims to describe the various inventive aspects and embodiments, “comprising” means including, but not limited to, whatever follows the word “comprising.” Thus, use of the term “comprising” indicates that the listed elements are required or mandatory, but that other elements are optional and may or may not be present. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Where used herein, if not otherwise defined, the term “substantially” means plus or minus five percent.

It is an object of this invention to provide a handheld shredding apparatus allowing users to shred material to be recycled or disposed of, such as cardboard boxes and the like.

It is a further object of this invention to provide such a hand-held shredder which is configured for engagement to a powered hand tool, such as a drill.

It is yet another object of this invention to provide such a hand-held shredder in a configuration where the shredder device is self-contained with an onboard battery and motor for powering the shredding component during use.

It is a still further object of this invention to provide users a means to enhance personal privacy through the provision of this device, which will shred personal data on the box, such as an address, and provider stickers along with shredding the box itself.

These together with other objects and advantages, which become subsequently apparent, reside in the details of the construction and operation of the disclosed portable handheld shredding device and system herein as more fully hereinafter described and claimed, reference being had to the accompanying drawings forming a part thereof, wherein like numerals refer to like parts throughout.

Further objectives of this invention may be ascertained by those skilled in the art as brought out in the following part of the specification, wherein detailed description is for the purpose of fully disclosing the invention without placing any limitations thereon.

### BRIEF DESCRIPTION OF DRAWING FIGURES

The accompanying drawings, which are incorporated herein and form a part of the specification, illustrate some, but not the only or exclusive, examples of embodiments and/or features of the disclosed handheld shredding device and method herein. It is intended that the embodiments and figures disclosed herein are to be considered illustrative of the invention herein, rather than limiting in any fashion.

In the drawings:

FIG. 1 shows a perspective view of the device herein having a first opening formed in a housing which communicates with a central area of a shredding assembly held within an internal cavity of the housing.

FIG. 2 shows a view of the device in a lower perspective view opposite that of FIG. 1, and showing a second opening in a lower surface of the housing from which the handle extends and depicts on an opposite side of the first opening.

FIG. 3 depicts a shredding assembly which is operatively positioned within an internal cavity of the housing showing the counter rotating blades configured to pull material through the assembly at a center area.

FIG. 4 shows the device of FIG. 1-2 wherein a power tool, such as a power drill or the like, is operatively connected with the power shaft extending from one side of the housing.

FIG. 5 shows the device as in FIG. 4 in operation, wherein material to be shredded is fed through the first opening, and is expelled by the shredding assembly in small pieces through the second opening.

FIG. 6 depicts the device herein with an onboard electric motor and battery to power the motor and with an optional second handle extending from a connection with the housing.

FIG. 7 shows another mode of the device similar to that of FIG. 6, but where the battery is removably engaged to the distal end of the handle and additionally acts as a counter weight.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right, first, second, and other such terms refer to the handheld shredding apparatus and operative components thereof as they are oriented and appear in the drawings, and all such terms are used for convenience only and such are not intended to be limiting or to imply that the handheld shredding device and system has to be used or positioned in any particular orientation.

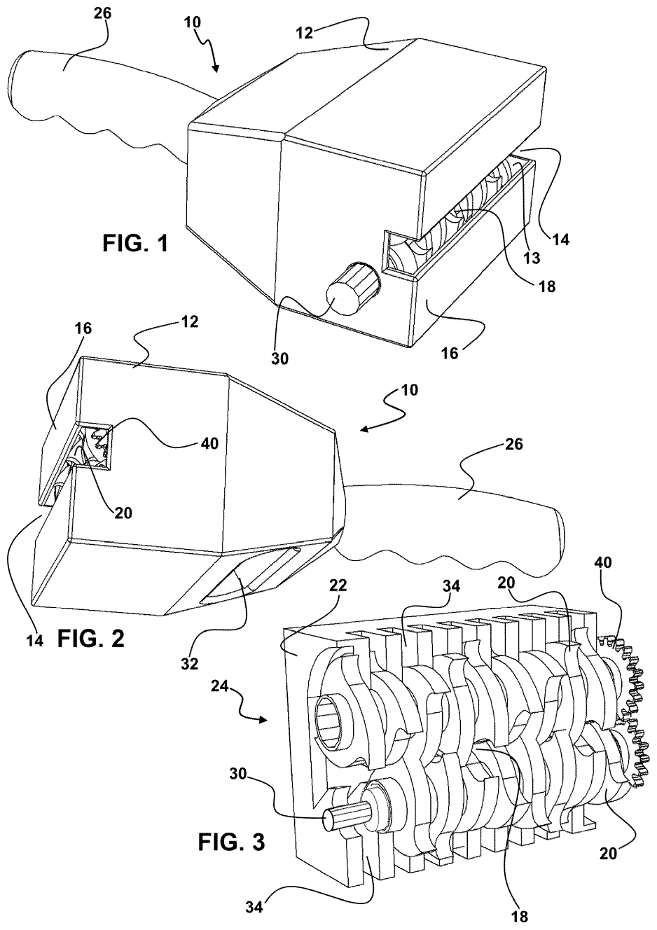

Now referring to drawings in FIGS. 1-7, there is seen in FIG. 1, a perspective view of the shredder device 10. As shown, the device 10 has a housing 12 having a first opening 14 formed in a first, or front side 16, of the housing 12. The first opening 14 provides a passage communicating with an interior cavity 13 of the housing 12. A shredding assembly 24 is positioned within the interior cavity 13, and has a central area 18 thereof located between two counter rotating blades 20 operatively engaged with a mount 22 of the shredding assembly 24 (FIG. 3). Dimensions such as the width, depth, and other dimensions of this first opening 14 may be formed to help prevent any communication of fingers of a user with the rotating blades 20.

A first handle 26 is coupled to the housing 12 at a first end thereof, and extends in a direction away from the housing 12 and the first opening 14 from this connection to a distal end of

the first handle 26. A power shaft 30 extends from an opening in one side of the housing 12, and is configured for operative coupling with a power tool for providing rotational power to the power shaft 30, such as an electric drill or air powered drill or the like. The power shaft 30 is operatively coupled to power the shredding assembly 24, and imparts rotational power to two counter rotating blades 20 of the shredding assembly 24 when the electric motor 48 or the motor of the handheld power tool is actuated.

In this fashion, rotation of the power shaft 30 during a user triggered rotation of the power tool, imparts rotation to the shredder assembly 24 a geared or direct connection to the counter rotating blades 20 during use.

In FIG. 2 is shown the device 10 from an opposite side from that of FIG. 1. As shown, a second opening 32 communicates through the wall of the housing 12 into the interior cavity 13. This second opening 32 is positioned below passages 34 formed in the mount 22 of the shredding assembly 24. These passages 34 provide a pathway through which material 36 (FIG. 5) fed into the first opening 14 and shredded into shredded material 38 by the shredding assembly 24 pass. The shredded material 38 will follow the passages 34 to exit from the second opening 32 wherein it may fall into a container or onto a surface.

As noted, the shredding assembly 24 is shown in a front perspective view in FIG. 3. The shredding assembly 24 is operatively positioned within the interior cavity 13 of the housing 12, such that the central area 18 between the counter rotating blades 20 substantially aligns with the first opening 14.

Also shown in FIG. 3, is the power shaft 30 rotationally coupled with the mount 22 and with gearing 40 or the like such that rotation of the power shaft 30 will cause counter rotation of the two counter rotating blades 20 which are configured to shred material 36 fed therethrough.

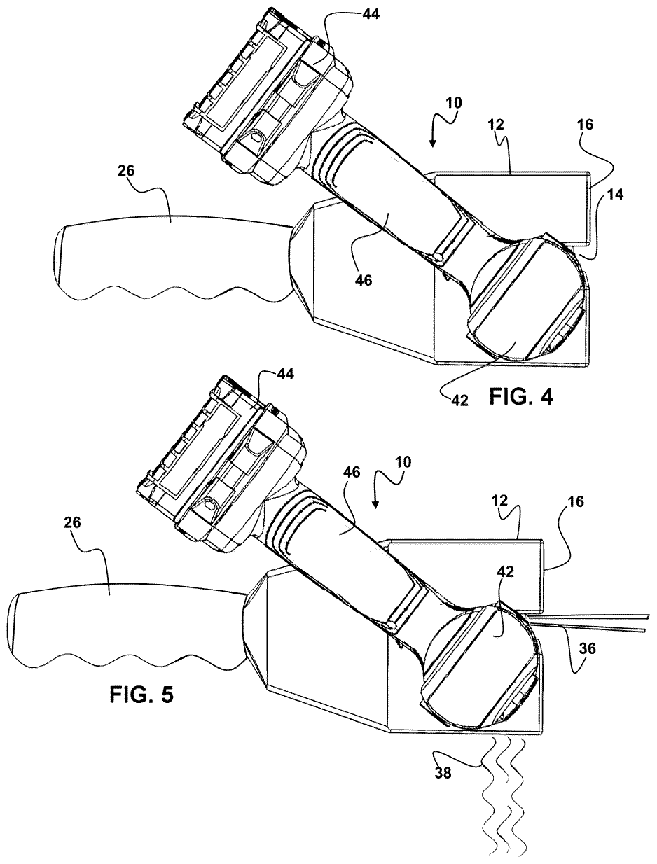

In FIGS. 4-5 is shown the device 10, as in FIGS. 1-2, in an operative configuration having a power tool 42 such as a drill or ratchet or similar electric power tool 42 engaged with the power shaft 30. Such an engagement with the power shaft 30 may be accomplished with a chuck or with a geared sleeve, which surrounds the exterior of the power shaft 30 or other means for engagement of the power tool 42 to the power shaft 30, which allows for communication of rotational power to the shredding assembly 24 once the power tool 42 is actuated by the trigger on the power tool 42. Preferably for portability, the power tool 42 may be battery 44 powered.

As shown in FIGS. 4-5, the handle 46 of the power tool 42 forms a second grip for a second hand of the user of the shredding device 10 during shredding of material 36 into shredded material 38. Since power tools 42 may rotate to any angular position during operating and gripping by the user, the angle of the handle 46 of the power tool 42 may be naturally adjusted by the user during use of the device 10 to one which is comfortable and provides the best resistance to rotation of the housing 12 during shredding.

It is envisioned that the device 10 may be provided with a

rotational power tool in the form of an onboard motor 48 to

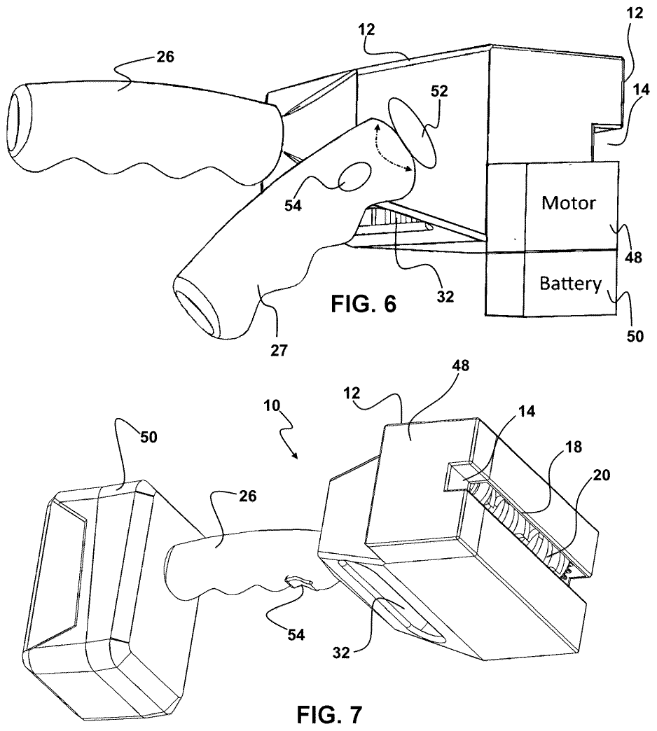

rotate coupled with the power shaft 30 to provide power to the shredding assembly 24 counter rotating blades 20 in a mode of the device 10 provided for use with an onboard power tool in the form of the electric motor 48. Such a configuration is shown in FIG. 6 wherein an electric motor 48 powered by a battery 40 is engaged with the housing 12. The electric motor 48 is operatively coupled with the power shaft 30 in this configuration and powered by the battery 50 to rotate the counter rotating blades 20 during use.

In this mode of the device 10, a second handle 27 may be coupled to the housing 12 to provide a second grip for the second hand of the user who is grasping the first handle 26 with a first hand. This second handle 27 may be coupled to the housing 12 in a pivoting coupling 52 to allow the user to adjust the angle from which the second handle 27 extends from the coupling to the housing 12 for both comfort, and to aid in a firm grasp of the device 10. A trigger 54 may be positioned on or adjacent one of the handles 26 or 27 to allow the user to actuate the motor 48 and the shredding device 10 when needed.

In FIG. 7 is depicted another mode of the device 10 similar to that of FIG. 6. As shown, the battery 50 is removably positioned on the distal end of the handle 26 and provides a removable source of power for the electric motor 48. The electric motor 48 may couple to the housing 12 while in operative coupling to the power shaft 30. The battery 50 in this configuration may act as a counter weight to better balance the device 10 when the handle 26 is held by the user. A second handle 27, as in FIG. 6, might also be included in this mode of the device 10. The mode shown in FIG. 7 would work especially well for inclusion in battery powered tool kits, such as those, and for example only, and in no way limiting, marketed by Ryobi Inc. of Anderson, S.C. where multiple power tools

performing multiple different tasks are all powered by a similarly configured battery 50, which is in a removable engagement to allow for recharging.

While all of the fundamental characteristics and features of the disclosed handheld shredding device herein, have been shown herein, with reference to particular embodiments thereof, a latitude of modification, various changes, and substitutions are intended in the foregoing disclosure. It will be apparent that in some instances, some features of the handheld shredding device may be employed without a corresponding use of other features without departing from the scope of the invention as set forth.

It should also be understood that various substitutions, modifications, and equivalent variations may be made by those skilled in the art, upon viewing this disclosure without departing from the spirit or scope of the invention. Consequently, all such modifications and variations and substitutions are considered included within the scope of the invention as defined by the following claims.

What is claimed is:

1. A handheld shredding apparatus comprising:
a housing, said housing having a front side and a rear side opposite thereto;
a shredding assembly operatively positioned within an interior cavity of said housing;
a first opening in said front side of said housing, said first opening defining a passage to said shredding assembly within said interior cavity for material to be shredded;
a first handle extending from a first end thereof coupled to said housing to a distal end, said first handle for gripping by one hand of a user;
a power shaft extending from said housing from a first end thereof operatively coupled with said shredding assembly to a distal end of said power shaft;
said distal end of said power shaft for coupling to a powered motor for imparting powered rotation to said shredding assembly; and
a second opening in said housing, whereby a user gripping said first handle may guide said material to be shredded into said first opening wherein said material is shredded by said shredding assembly and exits as shredded material from said second opening.

2. The handheld shredding apparatus of claim 1 additionally comprising:
said powered motor being an electric drill having a chuck operatively coupled to said power shaft, and having a drill handle and trigger for actuating said electric drill to rotate said chuck; and
said drill handle defining a second handle for gripping by a second hand of said user while said material is shredded by said shredding assembly.

3. The handheld shredding apparatus of claim 1 additionally comprising:
said shredding assembly having two counter rotating blades rotating toward a central area between said two counter rotating blades; and
said passage being aligned with said central area.

4. The handheld shredding apparatus of claim 2 additionally comprising:
said shredding assembly having two counter rotating blades rotating toward a central area between said two counter rotating blades; and
said passage being aligned with said central area.

5. The handheld shredding apparatus of claim 1 additionally comprising:
said distal end of said power shaft coupled to a powered motor which is coupled to said housing;
a battery removably coupled to said housing for powering said powered motor;
a trigger positioned on or adjacent said first handle for actuation of powered rotation of said powered motor.

6. The handheld shredding apparatus of claim 5 additionally comprising:
a second handle extending from a first end thereof coupled to said housing; and
said second handle for gripping by a second hand of a user.

7. The handheld shredding apparatus of claim 5 wherein said battery is removably coupled to said housing by a removable connection to said first handle.

8. The handheld shredding apparatus of claim 7 additionally comprising:
a second handle extending from a first end thereof coupled to said housing; and
said second handle for gripping by a second hand of a user.

9. The handheld shredding apparatus of claim 5 additionally comprising:
said battery being removably engageable with a plurality of different tools in a kit thereof, to provide electric power to each of said different tools.

10. The handheld shredding apparatus of claim 7 additionally comprising:
said battery being removably engageable with a plurality of different tools in a kit thereof, to provide electric power to each of said different tools.

11. The handheld shredding apparatus of claim 8 additionally comprising:
said battery being removably engageable with a plurality of different tools in a kit thereof, to provide electric power to each of said different tools.
